(19) United States
(12) Patent Application Publication
(10) Pub. No.: US 2020/0305461 A1
(43) Pub. Date: Oct. 1, 2020

(54) BACTERIOPHAGE ANIMAL FEED PRESERVATIVE

(71) Applicant: PURINA ANIMAL NUTRITION LLC, Arden Hills, MN (US)

(72) Inventors: Kay Russo, Arden Hills, MN (US); Theodore Karnezos, Arden Hills, MN (US)

(21) Appl. No.: 16/834,617

(22) Filed: Mar. 30, 2020

Related U.S. Application Data
(60) Provisional application No. 62/826,577, filed on Mar. 29, 2019.

(51) Int. Cl. A23K 10/18; A23K 50/75; A23K 40/30

(52) U.S. Cl. CPC A23K 10/18; A23K 40/30; A23K 50/75

(57) ABSTRACT

Methods involve feeding livestock animals, such as young poultry or calves, a feed product comprising a bacteriophage composition. The bacteriophage composition is configured to preserve the feed product and may exhibit lytic activity specific to one or more species of pathogenic bacteria, such as Salmonella, Escherichia, Campylobacter and/or Clostridium, which may be contaminating the feed product. The bacteriophage composition can remain in an inactive form until ingested by the animals, for example by including a protective outer coating, which may be comprised of digestible fat.

### CROSS-REFERENCE TO RELATED APPLICATIONS

This application claims priority to U.S. Provisional Application No. 62/826,577, filed Mar. 29, 2019, the entire contents of which are incorporated herein by reference.

### TECHNICAL FIELD

The present disclosure relates generally to feed for livestock supplemented with bacteriophages and systems and methods of feeding livestock such feed. Particular implementations involve methods of feeding poultry a bacterially contaminated feed supplemented with a bacteriophage composition.

### BACKGROUND

Gastrointestinal health and development is critical for livestock animals, especially at a young age, when the gut may be particularly sensitive to infection and disease. Poor gastrointestinal health can decrease animal feed intake and/or weight gain, thereby increasing the time it takes the animal to mature. Many animal feeding systems have been developed to promote gastrointestinal health, which often involve providing feed supplemented with vitamins, minerals, medication, and other components that may benefit the young animals. For example, young poultry are often fed enriched feed formulations that can reduce the point-of-lay age in pullets, thereby reducing the cost of egg production. Despite the success of existing feed formulations in enhancing various aspects of animal health, improved formulations remain desired.

### SUMMARY

Implementations provide methods of feeding livestock animals, such as poultry, a bacteriophage-supplemented feed.

According to embodiments of the present disclosure, a method of feeding livestock animals may involve feeding the livestock animals a feed product comprising a bacteriophage composition, where the bacteriophage composition is configured to preserve the feed product. In some examples, the feed product includes about 500 grams to about 1500 grams of the bacteriophage composition per ton of the feed product. In some embodiments, the livestock animals are poultry. In some examples, the poultry are fed the feed product between about 7 and about 14 days after birth. In some embodiments, in response to ingesting the feed product, the livestock animals increase a rate of weight gain. In some examples, the bacteriophage exhibits lytic activity specific to one or more species of Salmonella, Escherichia, Campylobacter and/or Clostridium. In some embodiments, the bacteriophage composition is inactive until ingested by the livestock animals. In some examples, the feed product is contaminated with a pathogenic bacteria. In some embodiments, the feed product is contaminated with about 10³ to about 10⁵ CFUs of the pathogenic bacteria per gram of the feed product. In some examples, the pathogenic bacteria include one or more species of Salmonella, Escherichia, Campylobacter, Clostridium or combinations thereof. In some embodiments, a moisture content of the feed product ranges from about 0.1 wt % to about 5 wt %. In some examples, the feed product comprises a starter mash composition formulated for poultry. In some embodiments, the feed product comprises a milk replacer formulated for calves.

In accordance with some examples of the present disclosure, an animal feed product includes a feed composition and a bacteriophage composition configured to preserve the feed product, where the bacteriophage composition exhibits lytic activity specific to one or more species of Salmonella, Escherichia, Campylobacter and/or Clostridium.

In accordance with some embodiments of the present disclosure, a feed product for young poultry includes a dry starter mash composition and a bacteriophage composition configured to preserve the feed product, where the bacteriophage composition exhibits lytic activity specific to one or more species of Salmonella, Escherichia, Campylobacter and/or Clostridium. In some examples, the bacteriophage composition is inactive until ingested by the young poultry. In some embodiments, the feed product is contaminated with a pathogenic bacteria. In some examples, the feed product is contaminated with about 10³ to about 10⁵ CFUs of the pathogenic bacteria per gram of the feed product. In some embodiments, the pathogenic bacteria include one or more species of Salmonella, Escherichia, Campylobacter, Clostridium or combinations thereof. In some examples, wherein a moisture content of the feed product ranges from about 0.1 wt % to about 5 wt %. In some embodiments, the dry starter mash composition includes yellow grain corn, dehulled soybean meal, and vegetable oil. In some examples, the bacteriophage composition is encapsulated in a protective fat coating. In some embodiments, the starter mash composition is encapsulated in a protective fat coating.

### BRIEF DESCRIPTION OF THE DRAWINGS

FIG. 1 is a graph showing the prevalence of Salmonella-positive cloacal samples obtained from chicks fed starter feed contaminated with Salmonella and supplemented with bacteriophages in accordance with embodiments disclosed herein.

FIG. 2 is a graph showing the concentration of Salmonella present within each of the Salmonella-positive cloacal samples represented in FIG. 1.

### DETAILED DESCRIPTION

Bacteriophages, or “phages,” are viruses that are ubiquitous in various naturally occurring ecosystems, present in the lung, vagina, oral and intestinal microbiota of both humans and animals. The role of phages in the gut is to maintain gut homeostasis by infecting host bacteria. Lytic phages infect the host bacteria, utilize the host cell's protein-making machinery to produce daughter phages, and then lyse (and kill) the host cell, releasing the daughter phages to continue the process. The feed products disclosed herein include lytic phages targeted for feed-derived bacterial pathogens, such as various species of Salmonella, Escherichia, Campylobacter and/or Clostridium. By lysing bacterial pathogens present in feed, the phage compositions described herein function as feed preservatives. The phage compositions can be included in feed products already contaminated with one or more bacterial pathogens, and in some embodiments, the phages may be activated in the presence of moisture within the gastrointestinal tract, i.e., after ingestion by an animal. The phage compositions provide a biological approach for reducing pathogenic content within the feed, thus representing a natural alternative to the chemical and/or caustic compositions in current use. Consumption of the phage-supplemented feed products disclosed herein may improve animal performance, for example by increasing weight gain, due to the reduced gastrointestinal bacteria content caused by the lytic activity of the phages in the feed. Cloacal samples collected from animals after ingesting bacterially contaminated, phage-supplemented feed according to embodiments disclosed herein may have reduced bacterial prevalence and/or content relative to animals offered the same bacterially contaminated feed without the phage supplementation.

### Feed Compositions Containing Phages

Feed compositions of the present disclosure may include or be admixed with phages. Accordingly, the final feed product may include a base feed supplemented with a phage composition. In various examples, the base feed may comprise a chick feed formulation, which may be a starter mash feed. While the specific feeds and associated methods described herein may pertain to poultry, other animals may be fed phage-supplemented feeds, including but not limited to dairy cows, beef cows, and/or swine. For instance, additional embodiments may include a calf starter or milk replacer composition admixed with phages, which may be provided to dairy and/or beef calves. Young poultry animals that may ingest the phage-supplemented feed include but are not limited to young chicks, ducks, geese, and turkeys.

The phages of the present disclosure may exhibit bacteria-specific lytic activity. For example, one or more phage strains may exhibit Salmonella-specific lytic activity, while one or more additional phage strains may exhibit lytic activity specific to one or more species of Escherichia, Campylobacter and/or Clostridium. Additional phage types are also within the scope of this disclosure, which is not limited to any particular phage.

The phage content of the phage composition added to the base feed may vary depending on the process used to manufacture the phage composition, the sources of phage used, the desired phage activity levels, and whether the phage composition includes a protective outer layer. In various embodiments, the phage composition may comprise a dry, powder-like substance having a pure phage content ranging from about 10 weight percent to about 100 weight percent, or about 20, 30, 40, 50, 60, 70, 80, or 90 weight percent, or any content therebetween.

The phages present within the phage composition may be provided in an inactive form. Such phages may be configured to activate only in the presence of elevated moisture and/or heat within the gastrointestinal tract. By remaining inactive until after ingestion, the phages may exhibit enhanced effectiveness. In particular, moisture- and/or heat-induced activation of the phages may increase the number of lytic phages available at the time of ingestion by reducing the number of phages that become inactive while the feed product remains exposed to exogenous pathogens. To maintain the phages in an inactive form until after ingestion, the phages may be encapsulated in a substance impermeable or substantially impermeable to moisture, which may be present in the feed or surrounding environment, thereby forming encapsulated phage particles. For example, the phages may be embedded or encapsulated in a controlled release coating comprised of one or more digestible fats and/or fatty acids configured to protect the phages from moisture in the feed, and also configured to release the phages in the gastrointestinal tract when the coating is digested. In some examples, the protective coating may encapsulate the phages, only, or the feed particles containing the phages, or both the phages and the phage-containing feed particles. The fat coating may be weather-resistant and flowable, such that the encapsulated phages are protected from various environmental factors, e.g., wind, rain and snow, and do not stick or clump together. Fats or waxes used to coat the phages may be in the form of high melting point fats that are solid or at least semi-solid at ambient temperatures, e.g., about 22° C. Such fats can include saturated fats, which may be hydrogenated, along with various free fatty acids or triglyceride fatty acids. Specific examples may include, but are not limited to: one or more medium to long chain saturated and unsaturated fatty acids and their salts, e.g., lauric acid, palmitic acid, myristic acid, stearic acid, oleic arachidic acid, pentadecanoic acid, heptadecanoic acid, nonadecanoic acid and eicosanoic acid, and/or fats such as palm stearin, palm fat, coconut oil, palmitoleic acid, animal fats such as beef tallow and pork fat, and combinations thereof. C3:0-C36:0 saturated fatty acids may be used. In some examples, the fats may be free or substantially free of non-digestible petrolatum. Other high melting point and digestible fat sources may be used in accordance with the present disclosure and are not limited to those enumerated herein.

The protective coating may constitute about 5 weight percent to about 80 weight percent of the encapsulated phage particles, or any amount therebetween, such as about 10 weight percent, 20 weight percent, 30 weight percent, 40 weight percent, 50 weight percent, 60 weight percent, 70 weight percent, or more. The resulting melting temperature of the protective coating may range from about 50° C. to about 80° C., about 55° C. to about 75° C., or about 60° C. to about 70° C.

In some examples, the protective coating may include one or more excipients configured to improve one or more physical properties of the coating, such as water resistance, viscosity, plasticity, adhesiveness, stress and temperature stability. Example excipients can include lecithin, clay, silica, terpenes, sterols, calcium and sodium salts.

The phage content of the final feed product, i.e., after mixing the base feed with the phage composition, may also vary and may be adjusted according to the needs and/or condition of the animal(s). In some embodiments, about 100 grams to about 2000 grams of the phage composition may be added per metric ton (i.e., 1,000 kilograms or 2,205 lbs.) of dry base feed. In other examples, the phage composition content may range from about 200, 300, 400, 500, 600, 700, 800, 900, 1000, 1100, 1200, 1300, 1400, 1500, 1600, 1700, 1800, or 1900 grams, or more, per ton of dry base feed. In various embodiments, the phage content may range from less than about 0.25 mg per gram of feed product, or from about 0.25 mg to about 0.85 mg per gram of feed product, or more, or any value therebetween, such as about 0.35 mg, 0.45 mg, 0.55 mg, 0.65 mg, or 0.75 mg per gram of feed product. The phage content may be an amount that is effective to improve performance of a young poultry animal.

The feed product may also be contaminated with one or more strains of bacteria, which may include species of Salmonella, e.g., Salmonella enteritidis, and/or species of Escherichia, Campylobacter and/or Clostridium, just to name a few. The level of contamination may vary. For example, a feed product may be contaminated with about 10³ to about 10⁵ CFUs of bacteria per gram of feed. Embodiments may also include feed products contaminated with about 10², 10⁴, or 10⁶ CFUs of bacteria per gram of feed.

In some embodiments, the base feed supplemented with phages may be a solid feed, e.g., starter mash, containing various levels of protein, fat, sugar, fiber, vitamins and/or minerals suitable for chicks. The total protein level of the base feed may be about 20 weight percent, such as about 18 to about 25 weight percent. Protein sources may include soybeans and/or grains, such as distillers grain or corn. Soybean-derived protein can include hydrolyzed soy protein modified, soy protein concentrate, and/or soy protein isolate. In some examples, the feed product may include yellow grain corn at a level ranging from about 40 to about 65 weight percent, or about 45 to about 55 weight percent, or about 50 to about 55 weight percent, or about 53 weight percent. In addition or alternatively, the feed product may include dehulled soybean meal at a level ranging from about 25 to about 55 weight percent, about 30 to about 50 weight percent, about 35 to about 45 weight percent, or about 40 weight percent.

The base feed may contain fat at a level of about 2 weight percent to about 6 weight percent, such as about 3, 4, or 5 weight percent, or any value therebetween. The fat may be partially or entirely sourced from vegetable oil in some examples. Grain byproducts may also be present in the feed product at about 6 weight percent to about 10 weight percent, e.g., about 8 weight percent. Molasses may be present in the feed product at about 2 weight percent to about 4 weight percent, such as about 3.1 weight percent. Fiber may be present in the feed product at about 1 weight percent to about 6 weigh percent, such as about 2, 2.5, 3.5, 4, 4.5, 5, or 5.5 weight percent. Amino acids may be present in the feed product at about 4 weight percent to about 8 weight percent, such as about 5.7 weight percent. Minerals, such as magnesium and calcium, may be present, for example at levels less than about 1 weight percent each, or at levels greater than 1 weight percent, such as 1.5, 2, 2.5, or 3 weight percent or higher. Specific embodiments may include dicalcium phosphate, for example at levels of about 1.5, 2, or 2.5 weight percent. Embodiments may also include calcium carbonate at levels of about 0.5, 1, 1.5, or 2 weight percent or higher. Specific embodiments may also include salt (NaCl) at levels ranging from about 0.1 to about 1 weight percent, e.g., about 0.2, 0.3, 0.4, 0.5, 0.6, 0.7, 0.8 or 0.9 weight percent. Examples may also include methionine at levels ranging from about 0.1 to about 1 weight percent, e.g., 0.2, 0.3, 0.4, 0.5, 0.6, 0.7, 0.8 or 0.9 weight percent. A vitamin premix may be included in the base feed at levels ranging from about 0.1 to about 0.8 weight percent, for example about 0.2, 0.3, 0.4, 0.5, 0.6 or 0.7 weight percent. Trace minerals may be present at or less than 0.1 weight percent, e.g., about 0.075 weight percent. Specific examples may also include about 0.012-0.020 weight percent L-lysine and/or about 0.020-0.030 weight percent BIO-D® or HY-D®.

The final feed product may be dry or substantially dry, such that moisture levels are zero, or close to zero. In some examples, moisture may be present in the feed at less than about 5 weight percent, e.g., between about 0.01 and about 4.9 weight percent, or less than about 12 weight percent, e.g., between about 5.1 and about 11.9 weight percent. Additional examples may include moisture levels greater than 12 weight percent, for example ranging from about 12.1 to about 20 weight percent. In such embodiments, the feed product may include phage particles encapsulated within a protective fat coating.

In some embodiments, the base feed may comprise a milk replacer composition. Milk replacers of the present disclosure may be produced according to traditional methods in which the fat and protein components of milk replacers are spray dried and combined into a milk replacer powder comprised of soluble or at least suspendable ingredients. Spray drying processes generally involve maintaining a spray dryer at temperatures between 100° C. to 200° C. so that the spray dried component rapidly heats and loses moisture. Following spray drying, the spray dried powder is subjected to a subsequent heating step, such as in a dryer drum, with an air temperature of between 100° C. to 200° C. in order to further reduce the moisture content of the powder.

The nutrient profile of the milk replacer generally includes fat and protein. The fat content may range from about 2.25 to about 4.7 wt % of the hydrated milk replacer or from about 15 to about 31 wt % of the milk replacer powder. The level of fat may be tailored for a target animal, and for instance, calf milk replacers may have the aforementioned fat content of between about 15 and about 31 wt % of the powder. In a more particular example, traditional calf milk replacers may include fat from about 20 to about 25 wt % of the powder or about 3 to about 3.75 wt % of the hydrated milk replacer, and full potential calf milk replacers may include fat from about 25 to about 31 wt % of the powder or about 3.75 to about 4.7 wt % of the hydrated milk replacer.

Predominant fat sources may be lard, tallow, palm kernel, or coconut oils, alone or in combination. In addition, some fat from lecithin and residual fat (e.g., butter fat, milkfat, or both) may contribute to the fat content in milk replacers.

Protein in milk replacers typically ranges from about 2.2 to about 5.1 wt % of the hydrated milk replacer or about 18 to about 30 wt % of the powder. For traditional calf milk replacers, the protein content may be about 22 wt % of the powder or about 3.3 wt % of the rehydrated milk replacer, and milk replacers formulated for enhanced performance, such as full potential milk replacers, may include protein at about 26 to about 28% of the powder or about 3.9 wt % to about 4.8 wt % of the rehydrated milk replacer.

Protein may be sourced from animal (e.g., milk, plasma, egg, and red blood cells) and vegetable sources and combinations thereof. Milk-derived protein sources are generally referred to as milk proteins and may include whey, casein, skim milk, sodium caseinate, and calcium caseinate.

### Feeding Methods

Implementations herein provide for phage-supplemented feed products and systems and methods of feeding the feed products to livestock, such as young poultry animals. The animals may be healthy young animals offered a feed product contaminated with bacteria, such as Salmonella. In various embodiments, the animals may be confined, e.g., within pens or cages, or free to roam. As described herein, feeding methods may vary for different animals. For example, young chicks may be fed a starter mash composition supplemented with phages, while young calves may be fed a phage-supplemented milk replacer composition. The daily feeding rate and/or the feeding period may vary for different feed types.

Feeding methods may generally involve obtaining a phage composition and combining it with a base feed just prior to feeding. Alternatively, the base feed may contain the phage composition. The phage-containing base feed may comprise a collection of discrete feed particles. In some embodiments, the feed product provided to the animals may be contaminated with bacteria, such as Salmonella enteritidis, at the time of feeding.

According to embodiments in which the phage composition and/or phage-containing feed product includes a protective coating, methods may also involve coating the phages, phage-containing feed particles, or both with a coating material, e.g., one or more fats and/or fatty acids, before feeding. In some examples, the coating material can be heated to form a flowable oil. The heating temperature may vary, ranging from less than about 140° F., to between about 140° F. and about 160° F., or higher. The heated oil can then be sprayed onto and/or tumbled with the phages or phage-containing feed particles. For example, the flowable oil can be transferred by a pump to a control valve for controlling the flow of the flowable oil to a spray nozzle. Upon reaching the spray nozzle, the flowable oil may be sprayed into a mixer holding the phages and/or phage-containing feed particles. As the mixer rotates, the sprayed oil forms a coating over the phages or phage-containing feed particles. The oil coating may later harden or dry and provide free-flowing, fat-coated particles.

The phage-supplemented feed product may be provided to the animals ad libitum, for example where the feed composition comprises a starter mash composition offered to chicks. In some approaches, young animals may ingest about 10 grams of the feed composition per head on day 1 post hatching, or between about 5 grams and about 20 grams of the feed composition per head per day from day 1 to about day 5. Feed consumption rates may increase as each animal ages, such that at about 42 days of age, each animal may be consuming about 210 grams of feed per day, or between about 150 and 250 grams per day. At about 68 days of age, each animal may be consuming about 260 grams of feed per day, or between about 210 and about 310 grams of feed per day. The young animals may ingest about 0.55 mg of the phage composition per gram of feed consumed, which may vary depending on the phage inclusion rate in the feed.

The age of the animals may vary. For example, the feeding methods described herein may be applicable to young animals beginning at about birth or at about 1, 2, 3, 4, 5, 6, 7, 8, 9, 10 weeks of age or older, or any age therebetween. The duration of the feeding method may also vary, for example ranging from about 1 day to about 7 days, or longer than 1 week, e.g., 2, 3, 4, 5, 6, 7, 8, 9, 10 weeks or more. In some embodiments, the young animal may ingest the feed product for about 1 week during the first 3 to 4 weeks of life, or over the course of the first 3 to 4 weeks of life, and beginning at any of the aforementioned ages or age ranges. In a particular example, the young animal may begin to ingest the feed product at 1 week of age, e.g., at day 7 or at day 8, and may ingest the feed product for 7 consecutive days. In additional examples, the disclosed feed product may be fed to animals of any age for any length of time. For example, a particular base feed may be supplemented with the phage composition for as long as the base feed is provided to the animals.

Methods of feeding milk replacer compositions supplemented with phages may differ from methods of feeding chick starter mash compositions, for example. In some embodiments, e.g., where the base feed comprises a milk replacer fed to calves, the young animals may be offered a fixed amount of feed per day, which may form all or a portion of the young animal's daily feed ration. Prior to the onset of weaning, the milk replacer in the feed ration may be offered twice per day, and may generally be divided into equal parts.

Milk replacers may be fed in traditional settings at a rate of about 1.25 pounds per head per day on a dry weight basis during the first week of life. Thereafter, the animal may be offered about 1.5 pounds of milk replacer per head per day on a dry weight basis. At the onset of weaning, the animal may be offered one feeding per day, totaling about 0.75 pounds of milk replacer per head per day on a dry weight basis.

In enhanced feed settings, full potential milk replacers may be fed at a rate of at least about 1.6 pounds up to about 3.0 pounds per head per day on a dry weight basis. For instance, in the first week of life, young animals, such as calves, in a full potential setting may be offered about 1.6 pounds or more (e.g., up to about 1.9 pounds) of milk replacer per head per day on a dry weight basis. From the second week of life onward, such animals in a full potential setting may be offered the same amount (about 1.6 pounds) of milk replacer or may be offered up to 3.0 pounds of milk replacer per head per day on a dry weight basis. Thereafter, the amount of milk replacer offered to the young animal may be maintained or the level may decrease, for example, depending on the timing of the onset of weaning.

The methods disclosed herein confer significant benefit on young livestock animals. In some embodiments, livestock animals are fed the disclosed feed product during a pre-weaning stage, such as between birth and about 3 weeks of age, or between about 1 and about 2 weeks of age. In other embodiments, the livestock animals are fed between birth and about 2, 4, or 5 weeks of age. In alternative embodiments, the livestock animals are fed between birth and about 6 or 7 weeks of age. In still other embodiments, the livestock animals are fed between birth and completion of the weaning process. Young livestock animals may be fed according to the methods disclosed herein over the entirety of any of the aforementioned periods, or for shorter subsets of time falling within or overlapping with these periods. Where the young livestock animals are fed phages through weaning, the phage level ingested may be reduced compared to phage levels ingested pre-weaning.

In addition to milk replacer, starter feed may be offered to the young animals on an ad libitum basis. Starter feeds, such as calf starter feeds, may include a mixture of one or more of corn, soybean meal, wheat middlings, oats, molasses, fat, ground cotton seed hulls, distillers grains, calcium carbonate, salt, and macronutrients and micronutrients. The starter feed may contain about 45 to 50% coarse ingredients such as corn, soy, and oats; about 16 to 22% protein; about 2 to 3% fat; about 5 to 6% fiber (determined on a NIR basis); about 7% acid detergent fiber; about 6% molasses; and the balance including a mixture of other nutrients. The amount of starter feed offered to the young animals may increase as the animals progress through the weaning process. In some embodiments, the milk replacer and the starter feed, or the starter feed only, may be admixed with the phage composition. For example, young calves may be fed a phage-supplemented milk replacer through a certain age, and then switched to a combination of milk replacer and starter feed, where only the starter feed contains the phage composition.

In addition to milk replacer, forage may be provided to the young animals to promote optimal digestive health. Sources of forage may include grasses, long-stem hay, hay cubes, and hay pellets. The amount of forage offered or provided to the young animals may increase as the animals progress through weaning.

In response to ingesting the phage-supplemented feed products disclosed herein, young livestock, e.g., poultry or calves, may exhibit improved performance. Improved performance may include, but is not limited to, improved weight gain, improved weight gain over a feeding period, improved feed efficiency, and/or improved feed efficiency over a feeding period. The improved performance may be realized after a feeding period. The improved performance may come without negatively affecting the animals' health. The improved performance exhibited by the animals may stem at least in part from a reduced prevalence and/or average content of bacteria present within the animals after ingesting the phage-supplemented feed, especially if such feed is contaminated with bacteria upon ingestion, compared to animals offered the same feed, but without the phages. The reduced bacterial prevalence and/or content within the animals may be achieved in as little as 1 week by feeding the animals according to the methods described herein. The aforementioned improvements in animal performance may be realized immediately and/or for long periods of time after the disclosed feeding methods are implemented. For example, chicks fed the bacterially-contaminated, phage-supplemented feed products disclosed herein from about day 8 post-hatching to about day 14-post-hatching may exhibit improved performance for numerous weeks, months or even years thereafter.

Implementations of the present disclosure are more particularly described in the following chick trial for illustrative purposes only. Numerous modifications and variations are within the scope of the present disclosure as will be apparent to those skilled in the art.

### EXAMPLES

Chick Trial 1

This study was conducted to investigate the efficacy of a dried phage product as an in-feed preservative to inactivate Salmonella enteritidis (hereinafter “Salmonella” or abbreviated “S.E.”) present in a chick feed.

Materials and Methods.

At the day of hatching, 270 male broiler chicks (Ross x Ross) sourced from Blairsville, Ga. were split evenly into 9 pens (30 chicks per pen) spread evenly between 3 isolation rooms (3 pens per room) in a test facility in Nicholson, Ga. The treatment groups were assigned to pens using randomized complete block design. Only healthy chicks were used, and no chicks were replaced during the study.

The test facility housing the chicks comprised a modified conventional poultry house with solid sides. The house had concrete floors, and the birds were raised under ambient humidity and according to a lighting program consistent with primary breeder recommendations. The floor space allotted per animal was about 1.00 square feet. One tube and 1 plasson drinker was included in each pen.

A broiler starter mash diet containing amprolium at 113.5 g/ton of feed was provided to the chicks ad libitum from days 1-8 after hatching. On day 8, the original, clean starter mash composition was replaced with a starter mash contaminated with Salmonella, which was then provided to the chicks ad libitum from day 8 through day 14 of the study. On day 14, the contaminated starter mash was replaced with the clean, i.e., Salmonella free, composition. The clean starter mash was then provided ad libitum from days 14-28. Water was also provided ad libitum for the duration of the study.

Salmonella inoculation involved adding, at the day of hatching, 10⁵ CFU Salmonella per gram of feed provided to the chicks from days 7-14.

The chicks were assigned to 3 treatment groups, in 3 replicate blocks. The first treatment group (Group 1) was fed a starter feed lacking bacteriophage and contaminated with Salmonella. The second treatment group (Group 2) was fed a starter feed containing 1000 g/metric ton bacteriophage and contaminated with Salmonella. The third treatment group (Group 3) was fed a starter feed containing 1500 g/metric ton bacteriophage and contaminated with Salmonella. For each treatment group, the Salmonella was added to the starter feed from day 7 to day 14 of the study, only. No concomitant drug therapy was used to treat the test animals. The experimental design of Chick Trial 1 is shown below in Table 1.

TABLE 1

| Treatment | Bacteriophage | |
|---|---|---|
| Group No. | Concentration in the Feed | S.E. Feed |
| 1 | 0 g/metric ton | Yes |
| 2 | 1000 g/metric ton | Yes |
| 3 | 1500 g/metric ton | Yes |

To measure the Salmonella content within each chick, Salmonella cultures were taken on day 28 of the study by euthanizing 25 birds from each cage and aseptically removing the ceca. The cecal samples were then placed in sterile plastic bags and stored on ice. The spleen and liver from each bird were also pooled to make 1 sample of internal organs per bird. In addition, cloaca swaps from 10 birds per pen were also taken at day 14 and day 21 and cultured individually for the presence and enumeration of Salmonella.

All samples submitted for Salmonella isolation and identification (spleen/liver, cloaca swab, and/or ceca) were transferred to an onsite laboratory for analysis. Upon arrival, tetrathionate broth was added after the ceca were weighed and the samples stomachered. A 1 mL aliquot was removed for MPN analysis, a tetrathionate broth solution added, and the samples incubated overnight at 41.5° C. A loopful of sample was then struck onto xylose lysine tergitol-4 agar (XLT-4 Difco) plates, which were then incubated overnight at 37° C. Up to 3 black colonies were then selected and confirmed as Salmonella positives using Poly-O Salmonella Specific Antiserum.

Isolated Salmonella was enumerated according to the MPN method. For all ceca and cloaca samples, a 1 mL sample of stomachered peptone broth was transferred to 3 adjacent wells in the first row of a 96-well plate, each well having a capacity of 2 mL. A 0.1 mL aliquot of sample was then transferred to 0.9 mL of tetrathionate broth in the second row, and the process repeated from the remaining rows to produce 5 ten-fold dilations. The blocks were incubated at 42° C. for 24 hours. After incubation, 1 μL of sample was removed from each well and plated onto XLT-4 agar, which contained nalidixic acid, with a pin-tool replicator. The plates were incubated at 37° C. for 24 hours and the Salmonella isolates confirmed by Poly-O Salmonella Specific Antiserum.

Throughout the study, all chicks were monitored for general flock condition, temperature, lighting, water, feed, pen condition, and unanticipated house conditions/events. Each pen was also checked daily for morality.

Results. The cloacal swab samples collected at day 14 from 10 chicks in each of 3 pens in each treatment group (30 chicks total per group) were analyzed for Salmonella content. As shown below in Table 2, the prevalence of Salmonella was 70% in the cloacal samples collected from Group 1 (21/30 chicks), which was provided a feed containing no bacteriophage. By contrast, Salmonella was found in only 20% (6/30 chicks) of Group 2 samples, which were obtained from chicks offered a feed having a bacteriophage content of 1000 g/metric ton, and 33.3% (10/30) of Group 3 samples, which were obtained from chicks offered a feed having a bacteriophage content of 1500 g/metric ton. The inclusion of bacteriophage in the feed significantly lowered the Salmonella prevalence compared to the untreated control (P<0.001).

TABLE 2

| Treatment | Bacteriophage | S.E. Prevalence |
|---|---|---|
| Group No. | Concentration in the Feed | (%) at Day 14 |
| 1 | 0 g/metric ton | 70 |
| 2 | 1000 g/metric ton | 20 |
| 3 | 1500 g/metric ton | 33.3 |

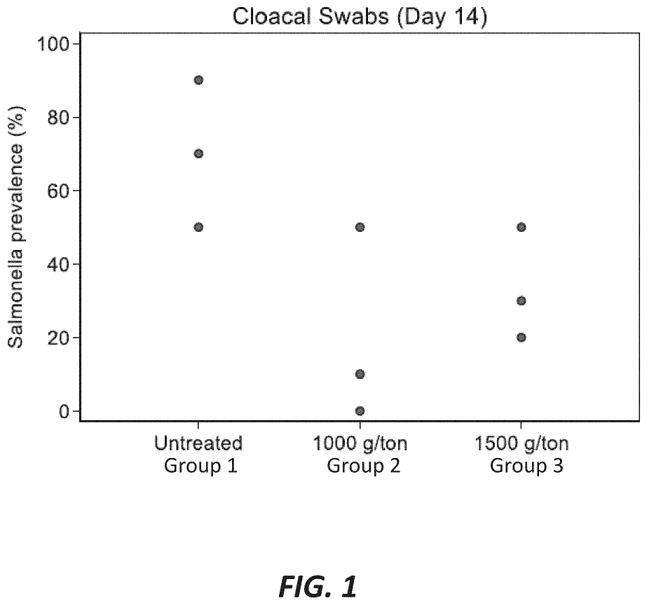

As shown in FIG. 1, the Salmonella-positive cloacal samples obtained per pen corroborated the summarized results of Table 2. In particular, cloacal samples from Group 1 revealed a per-pen Salmonella prevalence of about 50%, 70% and 90%. Cloacal samples from Group 2 revealed a per-pen Salmonella prevalence of only about 0%, 10% and 50%, and cloacal samples from Group 3 revealed a per-pen Salmonella prevalence of only about 20%, 30% and 50%.

The data shown in Table 2 and FIG. 1 indicates that including bacteriophage in Salmonella-contaminated chick feed can significantly lower the presence of Salmonella within the digestive systems of chicks offered the contaminated feed. Bacteriophage concentrations of at least about 1000 g per metric ton of feed may be sufficient to combat Salmonella contamination, and may even be optimal relative to higher bacteriophage concentrations of, for example, about 1500 g per metric ton of feed.

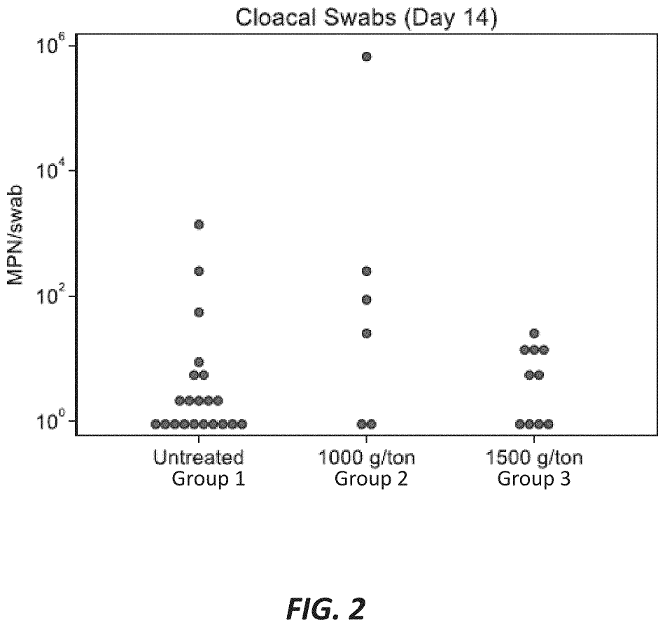

The Salmonella content was also determined by calculating the most probable number (MPN) of Salmonella (log₁₀) present in each of the culture-positive cloacal swab samples. The calculated MPNs for each treatment group are detailed below in Table 3 and displayed graphically in FIG. 2. As shown, there was no significant difference in Salmonella MPNs calculated per Salmonella-positive cloacal swab across the treatment groups, as the swabs from Group 1 contained an average of 0.61 (0.44) log₁₀ Salmonella, the swabs from Group 2 contained an average of 1.56 (0.73) log₁₀ Salmonella, and the swabs from Group 3 contained an average of 0.59 (0.51) log₁₀ Salmonella.

TABLE 3

| Treatment | Bacteriophage | S.E. log₁₀ |
|---|---|---|
| Group No. | Concentration in the Feed | MPN/swab |
| 1 | 0 g/metric ton | 0.61 (0.44) |
| 2 | 1000 g/metric ton | 1.56 (0.73) |
| 3 | 1500 g/metric ton | 0.59 (0.51) |

As shown in FIG. 2, the number of Salmonella-positive cloacal samples obtained from Group 1 were the greatest, but the average MPN from each treatment group was not significantly different. Notably, however, the average MPN/swab obtained for Group 2 may be skewed by one sample that had an MPN approximately 2 log₁₀ greater than the next highest MPN. If that outlier was excluded from the mean MPN calculation, the MPN for Group 2 would be only 0.88 (0.62) log₁₀ MPN/swab.

To further estimate the precise effects of bacteriophage treatment on the Salmonella MPNs and account for the Salmonella-negative cloacal swabs, which may truly contain a Salmonella MPN value of 0 or a Salmonella concentration below the culture method's minimum detection limit, a Tobit-regression model was applied. Applying this model, which censored the culture-negative samples at a concentration of −0.05 log₁₀ MPN/swab, attempted to estimate the true mean MPNs based on the distribution of MPNs in the culture-positive samples as well as the proportions of culture-negative samples in the different treatment groups.

Salmonella MPNs based on the Tobit censored regression model are summarized below in Table 4. As shown, there was no significant difference between treatments with respect to the log₁₀ Salmonella MPN/swab based on the Tobit censored regression model when all observations were included.

One of the cloacal swab samples obtained from Group 2 (1000 g bacteriophage/ton feed) had an MPN that was approximately 2 log₁₀ MPN/swab higher than the next highest MPN. If this observation was excluded, the estimated mean of the untreated group was increased to 0.07 (0.22) log₁₀ MPN/swab, the estimated mean of Group 2 was reduced to −1.02 (0.035) log₁₀ MPN/swab, and the estimated mean of Group 3 was increased to −0.63 (0.28) log₁₀ MPN/swab. The reduction in variance achieved by excluding the most extreme observation resulted in a significant overall treatment effect (P=0.014), with the samples from Group 2 having a significantly lower estimated mean than the untreated group, while the MPN for Group 3 was intermediate, and did not differ significantly from either Group 1 or Group 2.

TABLE 4

| Treatment | Bacteriophage | S.E. log₁₀ MPN/swab |
|---|---|---|
| Group No. | Concentration in the Feed | with culture-neg. censorship |
| 1 | 0 g/metric ton | −0.03 (0.30) |
| 2 | 1000 g/metric ton | −1.06 (0.43) |
| 3 | 1500 g/metric ton | −0.94 (0.38) |

These additional results suggest that bacteriophage inclusion within Salmonella-contaminated chick feed at concentrations of at least about 1000 g/metric ton of feed may also reduce the average Salmonella concentration present in the digestive systems of chicks fed the contaminated feed. By at least lowering the concentration of Salmonella present within the chicks' digestive systems, bacteriophage supplementation may thereby lessen the severity of the negative health effects frequently caused by Salmonella.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates, or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of feeding livestock animals, the method comprising:
feeding the livestock animals a feed product comprising a bacteriophage composition, the bacteriophage composition configured to preserve the feed product.

2. The method of claim 1, wherein the feed product includes about 500 grams to about 1500 grams of the bacteriophage composition per ton of the feed product.

3. The method of claim 1, wherein the livestock animals are poultry.

4. The method of claim 3, wherein the poultry are fed the feed product between about 7 and about 14 days after birth.

5. The method of claim 1, wherein in response to ingesting the feed product, the livestock animals increase a rate of weight gain.

6. The method of claim 1, wherein the bacteriophage exhibits lytic activity specific to one or more species of Salmonella, Escherichia, Campylobacter and/or Clostridium.

7. The method of claim 1, wherein the bacteriophage composition is inactive until ingested by the livestock animals.

8. The method of claim 1, wherein the feed product is contaminated with a pathogenic bacteria.

9. The method of claim 8, wherein the feed product is contaminated with about 10⁵ CFUs of the pathogenic bacteria per gram of the feed product.

10. The method of claim 8, wherein the pathogenic bacteria include one or more species of Salmonella, Escherichia, Campylobacter, Clostridium or combinations thereof.

11. The method of claim 1, wherein a moisture content of the feed product ranges from about 0.1 wt % to about 5 wt %.

12. The method of claim 1, wherein the feed product comprises a starter mash composition formulated for poultry.

13. The method of claim 1, wherein the feed product comprises a milk replacer formulated for calves.

14. An animal feed product, the feed product comprising:
a feed composition; and
a bacteriophage composition configured to preserve the feed product, wherein the bacteriophage composition exhibits lytic activity specific to one or more species of Salmonella, Escherichia, Campylobacter and/or Clostridium.

15. A feed product for young poultry, the feed product comprising:
a dry starter mash composition; and
a bacteriophage composition configured to preserve the feed product, wherein the bacteriophage composition exhibits lytic activity specific to one or more species of Salmonella, Escherichia, Campylobacter and/or Clostridium.

16. The feed product of claim 15, wherein the bacteriophage composition is inactive until ingested by the young poultry.

17. The feed product of claim 15, wherein the feed product is contaminated with a pathogenic bacteria.

18. The feed product of claim 17, wherein the feed product is contaminated with about 10⁵ CFUs of the pathogenic bacteria per gram of the feed product.

19. The feed product of claim 17, wherein the pathogenic bacteria include one or more species of Salmonella, Escherichia, Campylobacter, Clostridium or combinations thereof.

20. The feed product of claim 15, wherein a moisture content of the feed product ranges from about 0.1 wt % to about 5 wt %.

21. The feed product of claim 15, wherein the dry starter mash composition includes yellow grain corn, dehulled soybean meal, and vegetable oil.

22. The feed product of claim 15, wherein the bacteriophage composition is encapsulated in a protective fat coating.

23. The feed product of claim 15, wherein the starter mash composition is encapsulated in a protective fat coating.
